(19) United States
(12) Patent Application Publication
(10) Pub. No.: US 2015/0024427 A1
(43) Pub. Date: Jan. 22, 2015

(54) SOLUTION AND METHOD FOR ADHERING SUSPENSION COMPONENTS TO A SUBSTRATE

(71) Applicant: RareCyte, Inc., Seattle, WA (US)

(72) Inventors: Daniel Campton, Seattle, WA (US); Joshua Nordberg, Bainbridge Island, WA (US); Ronald Seubert, Sammamish, WA (US)

(73) Assignee: RareCyte, Inc., Seattle, WA (US)

(21) Appl. No.: 14/317,683

(22) Filed: Jun. 27, 2014

Related U.S. Application Data
(60) Provisional application No. 61/856,498, filed on Jul. 19, 2013.
(60) Provisional application No. 61/856,506, filed on Jul. 19, 2013.

(51) Int. Cl. G01N 1/30

(52) U.S. Cl. CPC G01N 1/30
USPC 435/30

(57) ABSTRACT

This disclosure is directed to a method and an attachment solution for adhering a cytological or histological sample, such as buffy coat, to a substrate, such as a microscope slide. The attachment solution includes an attachment base and an anti-coagulant. The attachment base may be an alcohol, an acid, an oxidizer, an organohalogen, a ketone, such as acetone, or any combination thereof, such as Carnoy's solution. Once a sample is obtained, the sample may be re-suspended in the attachment solution or the attachment solution may be added to the sample. The sample may then be dispensed onto an analysis platform as one or more droplets and cured. The sample may be spread on the analysis platform after having been dispensed. The sample may then be fixed, permeabilized, labeled, blocked, and washed. The sample may then be imaged and analyzed.

### CROSS-REFERENCE TO A RELATED APPLICATION

This application claims the benefit of Provisional Application No. 61/856,498, filed Jul. 19, 2013, and Provisional Application No. 61/856,506, filed Jul. 19, 2013.

### TECHNICAL FIELD

This disclosure relates generally to analyzing a suspension and, in particular, to a solution and method for adhering a component of a suspension to a substrate.

### BACKGROUND

Current diagnostic methods and techniques rely on the interpretation of histological and cytological samples. It is an important aspect in these interpretations that the sample remains adhered to a substrate on which the samples are being analyzed and processed, such as a microscope slide. Valuable diagnostic information may then be obtained from the sample upon subsequent processing due to the adherence of the sample.

### DESCRIPTION OF THE DRAWINGS

FIG. 1 shows a flowchart of an example method for making an example attachment solution.

FIG. 2 shows a flowchart of an example method for adhering a sample to a substrate.

FIG. 3A shows an example sample having been re-suspended in an example attachment solution.

FIG. 3B shows the example sample mixing with the attach solution to form a re-suspended cytological sample.

FIG. 3C shows the re-suspended sample being deposited on an example analysis platform.

FIG. 3D shows the re-suspended sample having been spread on and adhered to the analysis platform.

### DETAILED DESCRIPTION

This disclosure is directed to a method and an attachment solution for adhering a cytological or histological sample to a substrate. The attachment solution includes an attachment base and an anti-coagulant. The attachment base may be an alcohol, an acid, an oxidizer, an organohalogen, a ketone, such as acetone, or any combination thereof, such as Carnoy's solution. Once a sample is obtained, the sample may be re-suspended in the attachment solution or the attachment solution may be added to the sample. The sample is dispensed onto an analysis platform as one or more droplets and cured. The sample may then be fixed, permeabilized, labeled, blocked, and washed. The sample may then be imaged and analyzed.

The detailed description is organized into three subsections: 1) Descriptions of attachment solutions are provided in a first section. 2) Method of making the attachment solution is provided for in a second subsection. 3) Method of adhering a sample to a substrate is provided for in a third subsection.

In the following description, the term “sample” is used to describe a specimen to be analyzed. The specimen may be a suspension, a portion of the suspension, or a component of the suspension. For example, when the suspension is anticoagulated whole blood, the sample may be the anticoagulated whole blood (i.e. a suspension), the buffy coat (i.e. a portion of the suspension), or a circulating tumor cell (i.e. a component of the suspension).

### Attachment Solution

The attachment solution adheres a sample to a substrate. The sample can be a buffy coat of a blood sample and the substrate can be the surface of the a microscope slide. The attachment solution includes an attachment base and an anti-coagulant. The attachment solution may also include water or a buffered solution, such as phosphate buffered saline. The attachment base may include an alcohol, such as ethanol, methanol, propanol, isopropanol, butanol, and an acid, an oxidizer, an organohalogen, a ketone, such as acetone, or any combination thereof, such as Carnoy's solution. The attachment base may be capable of fixing sample components, such as cells, without cross-linking other sample components, such as proteins. Preventing cross-linking of the other sample components, such as proteins, may avoid an additional processing step, such as antigen retrieval. In other words, fixing sample components to a substrate with the attachement base eliminates the process of antigen retrieval. The attachment base may also have a fast (i.e. less than one hour) cure time. The attachment base may have a final concentration of approximately 40-90% by volume of the attachment solution. The final concentration of the attachment base may be determined by a measured property of the sample to be adhered including, but not limited to, sample volume, packed cell volume, hematocrit level, blood type, sample type (i.e. blood, urine, buffy coat, single cell, etc.), or the like. Furthermore, once the attachment solution and the sample have been mixed, the final concentration of the attachment base in the solution-sample mixture may be approximately 55-70% by volume.

The anti-coagulant portion of the attachment solution can be, but is not limited to, heparin, heparin sodium, heparin/dextrose, ethylene-diamine-tetra-acetic acid, dalteparin sodium, argatroban, bivalirudin, lepirudin, or the like. The anti-coagulant prevents coagulation (i.e. clumping, clotting or solidification) of the sample. The anti-coagulant may have a final concentration of approximately 10-1000 μg/mL.

The attachment solution may also include a biological polymer to increase the adhesion between the sample and the substrate. The biological polymer may include, but is not limited to, biomimetic adhesive polymers (such as polyphenolic protein from marine life; 3,4-dihydroxyphenylalanine), fibrin glue, gelatin-resorcinol-formaldehyde, poly-L-lysine, poly-D-lysine, or the like.

### Method of Making Attachment Solution

The following are example reagents used to make attachment solutions:
1. Heparin 2000 μμg/mL: Prepared by dissolving 20 mg of heparin sodium salt (Sigma H3393) in 10 mL of water
2. BD Cell-Tak: BD Cell-Take Cell and Tissue Adhesive (BD 354241)—approximately 1500 μg/mL stock concentration
3. Cell-Tak Buffer 5×: Prepared by dissolving 21 g sodium bicarbonate (NaHCO₃) into 500 mL of water
4. Cell-Tak Buffer 1×: Prepared by dissolving 4.2 g sodium bicarbonate (NaHCO₃) into 500 mL of water and adding 2.5 mL 1M hydrochloric acid (HCl)
5. Sigma Aldrich 494437: Methanol (about 99.93% by volume)

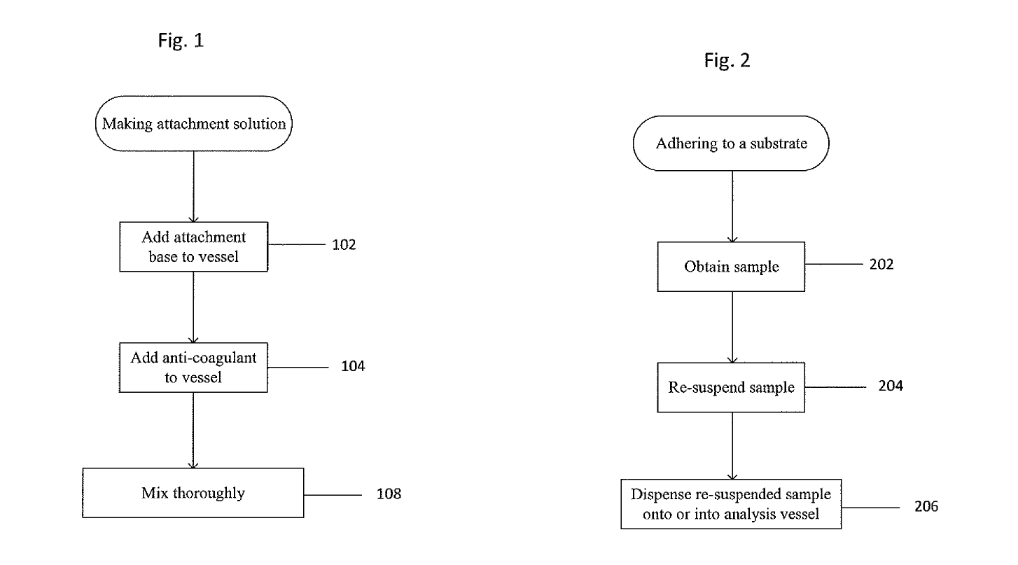

The following are example formulations for attachment solutions, as seen in FIG. 1:
1. 70% Methanol by volume, 100 ug/mL Heparin, 50 ug/mL Cell-Tak®:
   A. Mix 350 uL of Cell-Take with 650 uL of Cell-Tak Buffer 1×
   B. Mix thoroughly
   C. Add 1.5 mL of water
   D. Add 500 uL of Heparin 2000 ug/mL
   E. Add 7.0 mL of Methanol
   F. Mix thoroughly
2. 80% Methanol by volume, 200 ug/mL Heparin:
   A. Add 1.0 mL of Heparin 2000 ug/mL to 1.0 mL of water
   B. Add 8.0 mL of Methanol
   C. Mix thoroughly
3. 75% Methanol by volume, 100 ug/mL Heparin:
   A. Add 500 uL of Heparin 2000 ug/mL to 2000 uL of water
   B. Add 7500 uL of Methanol
   C. Mix thoroughly

### Method of Using Attachment Solution

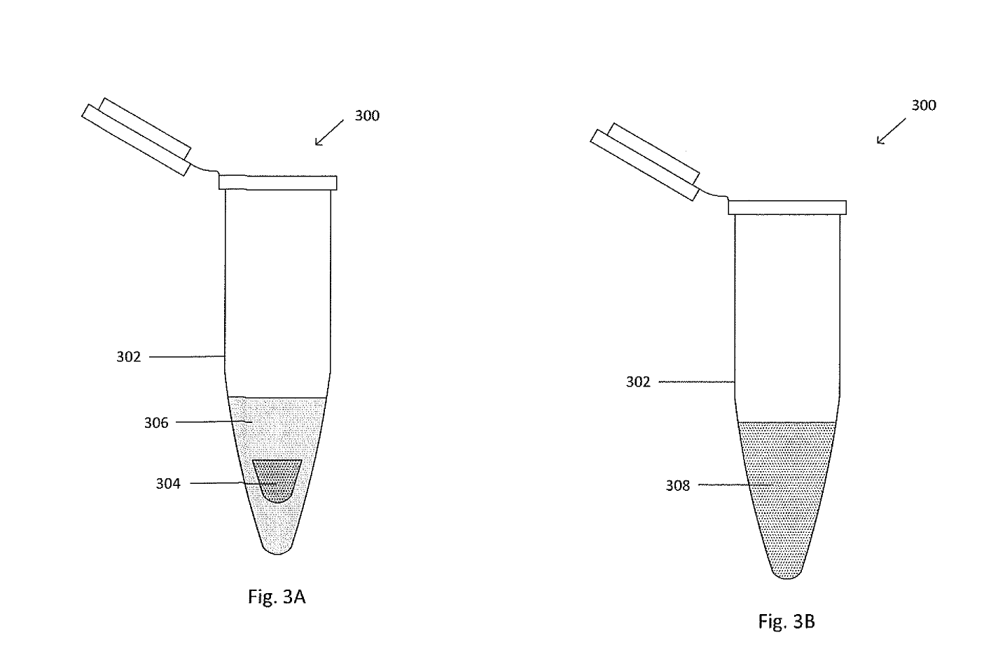

FIG. 2 shows an example method for adhering a sample to a substrate. In block 202, a sample is obtained. To obtain the sample, the sample may be withdrawn directly from a subject or the sample may undergo enrichment and/or isolation from the suspension. The sample may be enriched by any appropriate enrichment process including, but not limited to, sequential density fractionation, magnetic-activated cell sorting, fluorescence-activated cell sorting, differential lysis, depletion filters, or the like. Sequential density fractionation is a process by which a suspension is divided into fractions or a fraction of a suspension is divided into sub-fractions by a step-wise or sequential process, such that each step or sequence results in the collection or separation of a different fraction or sub-fraction from the preceding and successive steps or sequences. The sample may be obtained from other suspension components by selecting the sample with a device for picking, such as a cell picker, a pipet, a syringe, or the like.

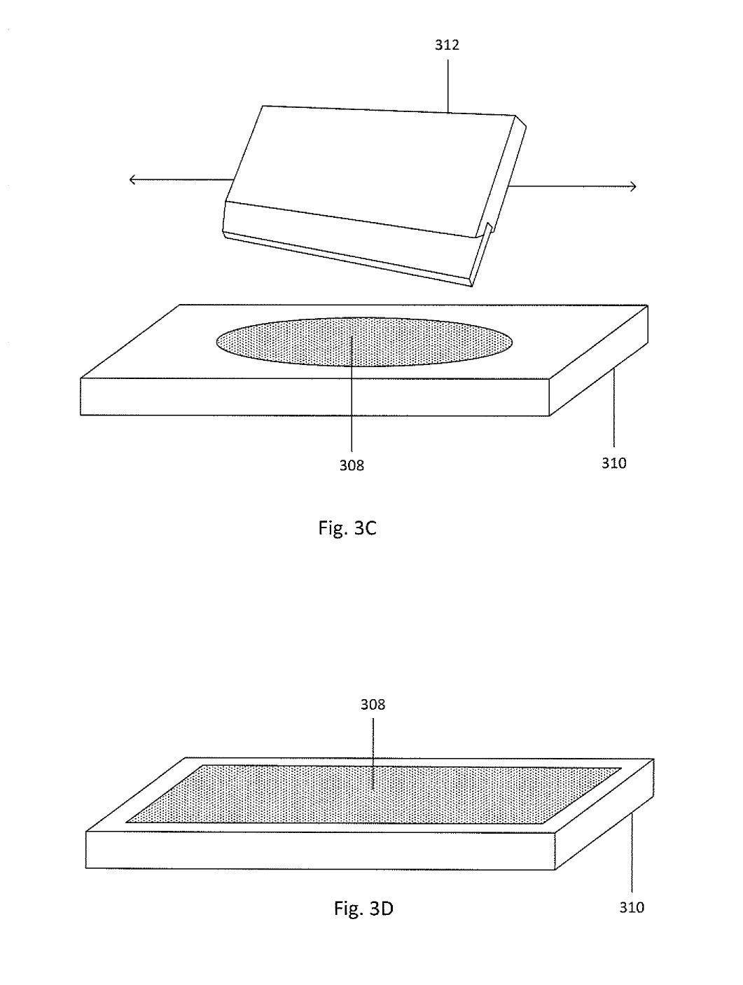

Referring back to FIG. 2, in block 204, the sample 304 is re-suspended in an attachment solution 306 in a vessel 302, as shown in FIG. 3A. Alternatively, the attachment solution may be added to or mixed with the sample. In block 206, the re-suspended sample 308, which includes at least a portion of the attachment solution, as shown in FIG. 3B, is dispensed onto or into an analysis platform 310 by a dispenser, such as a pipet or repeating pipet, and spread across the analysis platform. In FIG. 3C, the sample 308 is spread across the analysis platform 310 by a spreader 312, such as a squeegee, a pipet tip, a blade, a two-piece spreader including a blade and a base. Alternatively, the sample 308 may be spread across the analysis platform 310 by centrifuging, wetting, or nutating the analysis platform 310. The re-suspended sample 308 is cured, as shown in FIG. 3D, to adhere the re-suspended sample 308 to the analysis platform 310. Alternatively, the re-suspended sample 308 may be dispensed onto the analysis platform 310 and cured without being spread across the analysis platform 310. Curing may occur in air, such as at room temperature; in an environmentally-controlled chamber, such as at 37° C.; or the like. Furthermore, the sample may undergo an additional fixation step, such as in formalin or any appropriate fixative, after the curing step has been completed.

The attachment solution may be compatible with any appropriate analysis method or technique, though more specifically extracellular and intracellular analysis including immunofluorescent labeling and imaging; intracellular protein labeling; chromogenic staining; molecular analysis; genomic analysis or nucleic acid analysis, including, but not limited to, genomic sequencing, DNA arrays, expression arrays, protein arrays, and DNA hybridization arrays; in situ hybridization (“ISH”—a tool for analyzing DNA and/or RNA, such as gene copy number changes); polymerase chain reaction (“PCR”); reverse transcription PCR; or branched DNA (“bDNA”—a tool for analyzing DNA and/or RNA, such as mRNA expression levels) analysis. Some of the intracellular proteins which may be labeled include, but are not limited to, cytokeratin (“CK”), actin, Arp2/3, coronin, dystrophin, FtsZ, myosin, spectrin, tubulin, collagen, cathepsin D, ALDH, PBGD, Akt1, Akt2, c-myc, caspases, survivin, p27^{kip}, FOXC2, BRAF, Phospho-Akt1 and 2, Phospho-Erk1/2, Erk1/2, P38 MAPK, Vimentin, ER, PgR, PI3K, pFAK, KRAS, ALKH1, Twist1, Snaill, ZEB1, Fibronectin, Slug, Ki-67, M30, MAGEA3, phosphorylated receptor kinases, modified histones, chromatin-associated proteins, and MAGE.

The analysis platform 310 may be a microscope slide, a positively charged microscope slide, a coated microscope slide, a porous slide, a micro-well slide, a well plate, a coverslip, a cell microarray, or the like. The analysis platform 310 may be any appropriate material, including, but not limited to, glass, plastic, ceramic, metal, or the like.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented by way of examples for purposes of illustration and description. They are not intended to be exhaustive of or to limit this disclosure to the precise forms described. Many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

I/we claim:

1. A solution for adhering a sample to a substrate, the solution comprising:
approximately 40-90% methanol by volume; and
approximately 10-1000 ug/mL heparin.

2. The solution of claim 1, wherein the methanol has a final concentration of approximately 70-85% by volume.

3. The solution of claim 2, wherein the methanol has a final concentration of approximately 75% by volume.

4. The solution of claim 1, further comprising a biological polymer selected from the group consisting of fibrin glue, gelatin-resorcinol-formaldehyde, poly-L-lysine, and poly-D-lysine.

5. The solution of claim 1, further comprising a biomimetic adhesive polymer.

6. A method of adhering a sample to a substrate, the method comprising:
adding a solution including methanol and heparin to the sample to form a sample-solution mixture; and
dispensing the sample-solution mixture onto the substrate.

7. The method of claim 6, wherein the methanol in the solution has a final concentration of approximately 40-90% by volume.

8. The method of claim 7, wherein the methanol in the solution has a final concentration of approximately 70-85% by volume.

9. The method of claim 8, wherein the methanol in the solution has a final concentration of approximately 75% by volume.

10. The method of claim 7, wherein the final concentration of methanol by volume in the solution is determined by a measured property of the sample

11. The method of claim 6, wherein a final concentration of the methanol in the solution-sample mixture is approximately 55-70%.

12. The method of claim 6, wherein the heparin in the solution has a final concentration of approximately 10-1000 ug/mL.

13. The method of claim 12, wherein the methanol in the solution has a final concentration of approximately 40-90% by volume.

14. The method of claim 13, wherein the methanol in the solution has a final concentration of approximately 70-85% by volume.

15. The method of claim 14, wherein the methanol in the solution has a final concentration of approximately 75% by volume.

16. The method of claim 6, further comprising curing the sample-solution mixture on the substrate after the dispensing step.

17. The method of claim 16, further comprising spreading the sample-solution mixture across the substrate after the dispensing step and before the curing step.

18. The method of claim 16, further comprising fixing the sample-solution mixture with a fixative.

19. A method of making an attachment solution, the method comprising:
adding 1 part of heparin to 4 parts of water to form a heparin-water mixture; and,
adding 15 parts of about methanol to the heparin-water mixture.

20. The method of claim 19, wherein the methanol is about 99.93% methanol by volume; and wherein the heparin is heparin 2000 ug/mL which is prepared by dissolving heparin sodium salt in water, wherein about 2 mg of heparin are used per mL of water.
